(19) United States
(12) Patent Application Publication
(10) Pub. No.: US 2018/0161748 A1
(43) Pub. Date: Jun. 14, 2018

(54) FLUID-SEGMENTATION DEVICE, FLOW MIXING AND SEGMENTATION DEVICE, CONTINUOUS-FLOW REACTOR SYSTEM, AND METHOD FOR PRODUCING NANOPARTICLES

(71) Applicant: Shoei Chemical Inc., Tokyo (JP)

(72) Inventors: Daniel Peterson, Corvallis, OR (US); Patrick Michael Haben, Corvallis, OR (US); David Barsic, Portland, OR (US); Rachel Dreilinger, Beavercreek, OR (US)

(21) Appl. No.: 15/577,751

(22) PCT Filed: May 27, 2016
(86) PCT No.: PCT/JP2016/065694

§ 371 Date: Nov. 28, 2017

Related U.S. Application Data
(60) Provisional application No. 62/168,574, filed on May 29, 2015.
(60) Provisional application No. 62/173,274, filed on Jun. 9, 2015.

(51) Int. Cl. B01J 19/06; B01J 19/24

(52) U.S. Cl. CPC B01J 19/06; B01J 2219/00033; B01J 19/24

(57) ABSTRACT

The fluid-segmentation device according to an embodiment of the present invention includes: a first conduit in which a first fluid flows, and a second conduit in which a second fluid immiscible with the first fluid flows. The second conduit of the fluid-segmentation device includes an intersection region, to which the first conduit is connected and into which the first fluid is introduced, and a first region downstream of the intersection region. The cross-sectional area of the intersection region of the second conduit in a plane perpendicular to the flow direction of the second fluid is less than the cross-sectional area of the first region of the second conduit in a plane perpendicular to the flow direction of the second fluid.

### TECHNICAL FIELD

The present invention relates to a fluid-segmentation device, a flow mixing and segmentation device, a continuous-flow reactor system, and a method for producing nanoparticles. More specifically, the present invention relates to a fluid-segmentation device, a flow mixing and segmentation device, a continuous-flow reactor system, and a method for producing nanoparticles which are suitable for producing nanoparticles such as nanocrystalline materials, nanocrystallites, nanocrystals, quantum dots, and quantum dot materials.

### BACKGROUND ART

Continuous-flow processing for chemical synthesis has various advantages over batch processing, including but not limited to higher throughput. A continuous-flow reactor system may include one or more reaction zones—e.g., zones of controlled temperature, controlled irradiation, controlled exposure to a catalyst, etc. In kinetically controlled processing, the time in the reaction zone determines the degree of progress of the reaction. This parameter is called the ‘residence time’. A practical issue in continuous-flow processing is that reactant species flowing through a conduit, even at a constant flow rate, exhibit a distribution of velocities in the wall-normal direction. As a result, the residence time follows a non-uniform distribution, rather than being uniform with respect to a given flow rate. The variable residence times for the reactant species may give rise to kinetically controlled products having variable chemical composition and/or physical properties (e.g., particle size, morphology, etc.), which can be undesirable.

### CITATION LIST

### Patent Literature

Patent Literature 1: U.S. Pat. No. 6,179,912
Patent Literature 2: U.S. Pat. No. 6,322,901
Patent Literature 3: U.S. Pat. No. 6,833,019
Patent Literature 4: U.S. Pat. No. 8,101,021
Patent Literature 5: U.S. Pat. No. 8,420,155
Patent Literature 6: U.S. Patent Application Publication No. 2012/0315391
Patent Literature 7: U.S. Patent Application Publication No. 2014/0264171
Patent Literature 8: Japanese Patent Application Publication No. 2006-188666

### SUMMARY OF THE INVENTION

### Technical Problem

As described above, the reactant species flowing through the conduit at a constant flow rate exhibit a non-uniform velocity distribution in the wall-normal direction. As a result, the residence times are not uniform for a given flow rate, but follow a distribution, which can lead to kinetically controlled products having variable chemical composition and/or physical properties (e.g., particle size, morphology, etc.). One remedy for this issue is to create an immiscible, two phase segmented flow of the reactant or reactants through one or more reaction zones in a continuous-flow reactor system. U.S. Pat. No. 8,101,021 discloses a method for producing nanocrystals by using a segmented-flow method in which a liquid containing a reactant and a gas are alternately transported in a flow channel. In this approach, segments of a flowing reactant are separated by intervening segments of an immiscible, non-reacting fluid. Confined to relatively short, flowing segments, the reactant exhibits a tighter distribution of residence times in the reaction zones, resulting in a more uniform distribution of kinetically controlled products.

However, the segmented-flow approach in chemical synthesis may increase costs for at least two reasons. First, continuous supply of an unrecoverable, non-reacting fluid may add to the expense of a process. Second, the non-reacting fluid occupies volume in the continuous-flow reactor system that could otherwise be used to make product.

Accordingly, examples are disclosed herein that relate to creating a segmented reactant flow in a manner that helps to mitigate these issues.

Further, the segmented-flow approach presents challenges in continuous chemical analysis of flowing reaction, mixtures, for example, in automatic feedback for process control or quality assurance. In particular, the intervening segments of non-reacting fluid may erode the fidelity of a photometric assay.

Accordingly, examples are disclosed herein that relate to efficiently assaying chemical species in a segmented flow system that helps to mitigate such issues.

### Solution to Problem

An example relating to efficient segmentation of fluid within a continuous-flow reaction system is disclosed. One embodiment of the present disclosure uses the following configuration.

(1) A fluid-segmentation device including:

a first conduit in which a first fluid flows, and

a second conduit in which a second fluid immiscible with the first fluid flows, wherein

the second conduit of the fluid-segmentation device includes an intersection region, to which the first conduit is connected and into which the first fluid is introduced, and a first region downstream of the intersection region, and

a cross-sectional area of the intersection region of the second conduit in a plane perpendicular to the flow direction of the second fluid is

less than a cross-sectional area of the first region of the second conduit in a plane perpendicular to the flow direction of the second fluid.

(2) The fluid-segmentation device of (1), wherein the first fluid is a gas and the second fluid is a liquid.

(3) The fluid-segmentation device of (1) or (2), wherein the second conduit further includes a widening region that continuously widens in the flow direction of the second fluid at a position between the intersection region and the first region.

(4) The fluid-segmentation device of (3), wherein the second conduit further includes a constant-width portion, having an inner diameter substantially equal to that of the intersection region, between the intersection region and the widening region.

(5) The fluid-segmentation device of any one of (1) to (4), wherein the first conduit further includes a metering stage that controls an amount of the first fluid introduced into the intersection region on the basis of a flow rate of the second fluid.

(6) A flow mixing and segmentation device including

the fluid-segmentation device of (1), and

a mixing structure for mixing a plurality of fluids, wherein

the mixing structure introduces a mixture, obtained by mixing the plurality of fluids, as the second fluid into the second conduit of the fluid-segmentation device.

(7) The flow mixing and segmentation device of (6), wherein the mixing structure includes a homogenization structure for homogenizing the mixture.

(8) The flow mixing and segmentation device of (6) or (7), wherein the mixing structure and the fluid-segmentation device are formed integrally.

(9) A continuous-flow reactor system including

the fluid-segmentation device of (1), and

a reaction processing device including a processing device which is connected to the second conduit further downstream of the first region of the second fluid and causes the second fluid to react.

(10) The continuous-flow reactor system of (9), wherein

a conduit receiver including an upstream conduit-fill sensor, an analytical sensor, and a downstream conduit-fill sensor located at a position between the upstream conduit sensor and the analytical sensor is provided at a position downstream of the intersection region of the second conduit, and

the conduit receiver is configured such that the upstream conduit-fill sensor is disposed on the upstream side in the flow direction of the second fluid and the analytical sensor is disposed on the downstream side in the flow direction of the second fluid.

(11) The continuous-flow reactor system of (9) or (10), wherein

the reaction processing device and the intersection region of the fluid-segmentation device are thermally insulated.

(12) A method for producing nanoparticles, including:

preparing the continuous-flow reactor system of any one of (9) to (11), and

energizing and/or activating the second fluid in the reaction processing device.

(13) A method for producing nanoparticles, including:

a step of introducing a first fluid into a conduit in which a second fluid immiscible, with the first fluid flows, to form a segmented flow of the second fluid, which is separated by intervening segments of the first fluid, and delivering the segmented flow toward a downstream in a flow direction of the second fluid;

a step of passing the delivered segmented flow through a widening region of the conduit, with the region being configured such that a cross-sectional area of the conduit in a plane perpendicular to the flow direction widens, thereby shortening the intervening segments of the segmented flow in the flow direction; and

a step of introducing the segmented flow, in which the intervening segments are shortened, into the conduit arranged at a position passing through a reaction processing device including a processing device for causing the second fluid to react, and energizing and/or activating the second fluid of the segmented flow in the conduit.

The Summary above is provided to introduce a selected part of this disclosure in simplified form, not to identity key or essential features. The claimed subject matter, defined by the claims, is limited neither to the content of this Summary nor to implementations that address the problems or disadvantages noted herein.

### Advantageous Effects of the Invention

In accordance with the present invention, it is possible to provide a fluid-segmentation device, a flow mixing and segmentation device, a continuous-flow reactor system, and a method for producing nanoparticles that use a small amount of non-reacting fluid and can form good flowing segments.

Further, with the method for producing nanoparticles of the present invention, it is possible to obtain a more uniform distribution of kinetically controlled products.

### BRIEF DESCRIPTION OF THE DRAWINGS

FIG. 1 schematically shows aspects of an example continuous-flow reactor system using a segmented flow of reactants.

FIG. 2 shows aspects of an example, flow mixing and segmentation device.

FIG. 3 shows aspects of an example analytical device for a continuous-flow reactor system.

FIG. 4 illustrates aspects of an example process flow to control the timing of the acquisition of analytical data in a continuous-flow reactor system.

### DESCRIPTION OF EMBODIMENTS

### First Embodiment

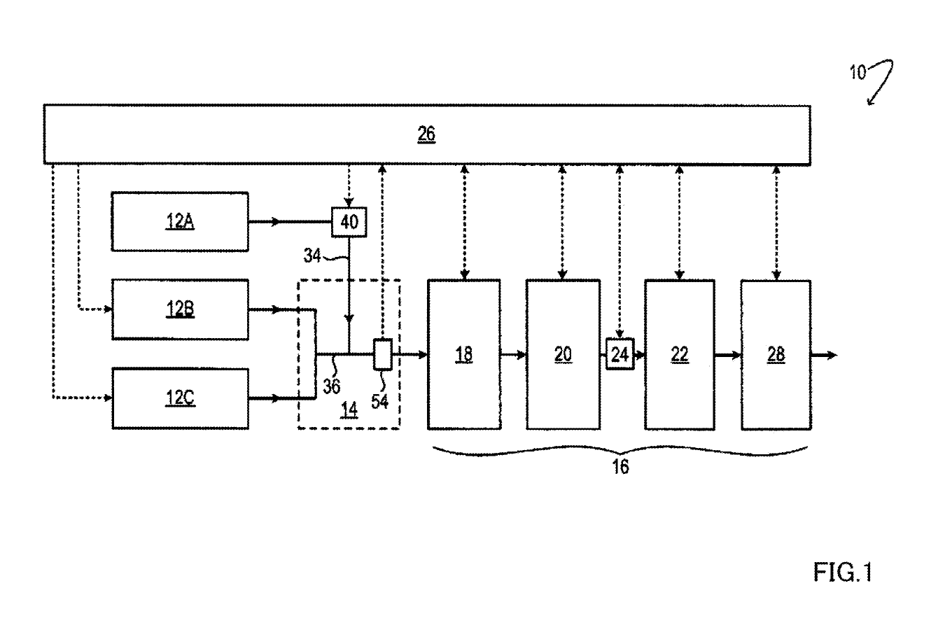

FIG. 1 shows aspects of an example continuous-flow reactor system 10 that uses segmented reactant flow to provide a narrower distribution of residence times than without segmentation. The continuous-flow reactor system includes a plurality of fluid sources 12—e.g., first fluid source 12A, second fluid source 12B, and third fluid source 12C. Fluid sources 12 may include compressed-gas cylinders, pumps, and/or liquid reservoirs, for example. The continuous-flow reactor system also includes a flow mixing and segmentation device 14 and a reaction processing device 16 constituted of at least one or more processing devices arranged fluidically downstream of the flow mixing and segmentation device (in the case shown in FIG. 1, an energized activation stage 18, an incubation stage 20, a collection stage 22, an analytical device 24, a shell forming stage 28). The reaction processing device is a generic term for individual processing devices; in other embodiments, any suitable number of processing devices other than the mentioned processing devices may be arranged downstream of the flow mixing and segmentation device.

The continuous-flow reactor system of FIG. 1 may be used in any of a number of chemical syntheses, including but not limited to the synthesis of nanoparticles. Classified as nanocrystalline materials, nanocrystallites, nanocrystals, quantum dots, and quantum dot materials, nanoparticles are produced and used for a wide variety of applications. For example, nanoparticles of a metal or a compound thereof can be used for the production of a conductive ink capable of forming wiring, electrodes, etc., a conductive adhesive, etc. Alternatively, semiconductor nanocrystals emitting visible light over a narrow range of wavelengths can be used for the product-ion (c)flight emitting diodes (LEDs) and LED matrices.

Non-limiting examples of materials and processes for making nanocrystalline quantum dot materials are described in U.S. Pat. No. 6,179,912 (Patent Literature 1), U.S. Pat. No. 6,322,901 (Patent Literature 2), U.S. Pat. No. 6,833,019 (Patent Literature 3), U.S. Pat. No. 8,101,021 (Patent Literature 4), and U.S. Pat. No. 8,420,155 (Patent Literature 5), in U.S. Patent Application Publication Numbers 2012/0315391 (Patent Literature 6) and 2014/0264171 (Patent Literature 7), and in Japanese Patent Application Publication Number 2006/188666 (Patent Literature 8). Each of these disclosures is hereby incorporated by reference herein.

Continuous-flow reactor system 10 includes a flow channel including a second conduit 36 that passes through a reaction processing device 16. In flow mixing and segmentation device 14, suitable precursor species are metered, mixed together, and delivered into the flow path, where an immiscible, non-reacting fluid is inserted to provide segmented flow of the mixture (vide infra). In some examples, the precursors may include a reducing agent and one or more cationic precursors. In other examples, the precursors may include one or more anionic precursors and one or more cationic precursors.

From flow mixing and segmentation device 14, the segmented reaction mixture and immiscible fluid are delivered to reaction processing device 16. Reaction processing device 16 includes energized activation stage 18 in which the mixture is rapidly energized. An energy source such as a microwave source, for example, a single-mode, multi-mode or multi-variable frequency microwave source may be used, or a heating means such as a heater or an oven may be used for the energization. Here, the precursors are rapidly and uniformly nucleated. The flow of the nucleated precursors then passes into incubation stage 20, where a heat source promotes growth of the nucleated precursors. The process is quenched in collection stage 22, where the resulting nanoparticles are separated from the immiscible, non-reacting fluid. In other implementations, the energized activation stage 18 may be omitted, as nucleation and growth may occur in a same reactor stage. In other embodiments, reaction processing device 16 includes other steps, such as preheating, before and/or after energized activation stage 18.

In the example of FIG. 1, analytical device 24 is arranged fluidically upstream of collection stage 22. In the analytical device, an assay may be conducted that tests one or more physical properties of the nanoparticles emerging from the incubation stage. In some examples, the analytical device may communicate with process controller 26, operatively coupled to fluid sources 12 and to various inputs of reaction processing devices 16. Such inputs may include energy flux in energized activation stage 18, heating in incubation stage 20, and various flow-control componentry arranged throughout the system. Closed-loop feedback based on the assayed property or properties may be used to automatically optimize or fine-tune nanoparticle size, composition, or other properties.

As shown in FIG. 1, a shell fabrication stage 28 may be arranged downstream of collection stage 22 to allow one or more shell layers to be formed over each nanoparticle. In some examples, shell-forming stage 28 may include two or more stages arranged in sequence—e.g., shell-forming stage A, shell-forming stage B, etc.

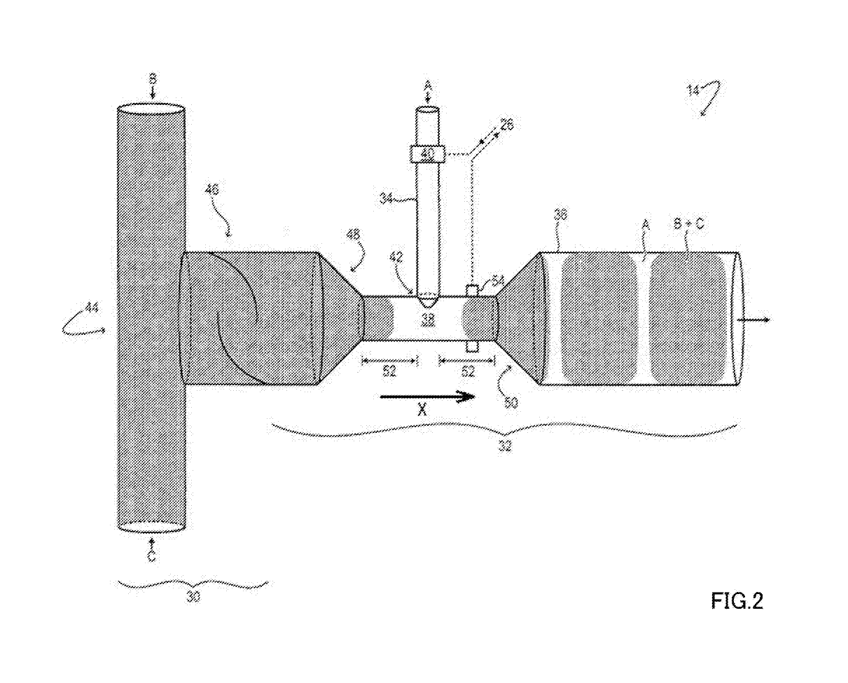

FIG. 2 shows aspects of an example of flow mixing and segmentation device 14 in greater detail. The flow mixing and segmentation device includes mixing structure 30 arranged fluidically upstream of fluid-segmentation device 32. Fluid-segmentation device 32 includes a first conduit 34 and a second conduit 36 that intersects the first conduit 34 in intersection region 38. The term ‘conduit’ refers herein to a fluid conduit—i.e., a conduit for liquid and/or gas. The conduits can be made of any suitable material, including but not limited to glass, ceramic, metal, and/or plastic, depending on the physicochemical properties of the fluids carried therein. In some examples, conduits may be machined, etched, or micromachined from a block of conduit material.

Continuing with FIG. 2, first conduit 34 is configured to admit a first fluid A and introduce the first fluid into second conduit 36 at intersection region 38. First fluid A is composed of a liquid or a gas. The first conduit includes a metering stage 40 configured to control the amount of the first fluid A admitted into the intersection region. The metering stage may include any type of actuatable valve—e.g., an electronic or pressure-actuated valve. In the example shown in FIG. 2, the first conduit terminates at a nozzle 42, and nozzle 42 penetrates the second conduit so as to introduce first fluid A into the second conduit.

Mixing structure 30 is coupled to second conduit 36 upstream of intersection region 38. The mixing structure is configured to admit second and third fluids B and C, and to release a mixture of the second and third fluids through the second conduit and into the intersection region. The mixture flows in second conduit 36 in the direction of the arrow indicated by X in the figure, and after passing through intersection region 38, the mixture is delivered as a segmented flow including the first fluid, to reaction processing device 16 positioned downstream of flow mixing and segmentation device 14.

In the example considered herein, one or both of the second fluid and the third fluid may be a liquid, that is, a pure liquid, or a solution in which one or more a plurality of solids, liquids, or gases is dissolved, or a dispersion in which solid particles or immiscible liquid or gas regions are suspended in a liquid. The mixture formed by mixing the second fluid and the third fluid may also be a liquid. The first fluid may be, for example, a compressed and/or purified gas, that is, air, carbon dioxide, nitrogen, argon or helium. For example, a gas from a gas source such as a pressurized tank may be supplied with the first fluid to first conduit 34 by controlling the pressure by a pressure controller and controlling the flow rate by a mass flow controller. Hereinafter, unless otherwise specified, the case where the first fluid is a gas and the mixture is a liquid will be exemplified. In this case, the gas may be sparingly soluble in the liquid and/or the liquid may be saturated therewith. Thus, the first fluid and the mixture may be in immiscible relationship with each other. In one non-limiting example relating to nanoparticle synthesis, the second fluid may be a solution of a cation precursor compound and the third fluid may be a solution of a reducing agent. The first fluid is preferably purified nitrogen, argon or helium. By virtue of the intersecting flow of the first fluid into the mixture of the second and third fluids, the second conduit is configured to conduct a sequence of flowing segments of the mixture away from intersection region 38, separated by intervening segments of the first fluid. For example, an intervening segment composed of the first fluid is formed to fill intersection region 38, and the intervening segment is moved downstream of intersection region 38 by the flow of the second fluid. Due to repetition of such operations, the segmented flow of the second fluid separated by the intervening segments may be guided from intersection region 38 to a position downstream thereof.

In the illustrated example, mixing structure 30 includes a “T” coupling 44, in which the second and third fluids approach second conduit 36 from opposite directions along the same axis. In other examples, the second and third fluids may approach at an angle. The mixing structure of FIG. 2 includes a randomly selected homogenization structure 46 to enhance homogenization of the mixture of the second fluid and the third fluid. Homogenization structure 46 may include a protrusion formed on the inner wall of the second conduit, for example, at a position downstream of “T” coupling 44. By changing the flow of the mixture of the second fluid and the third fluid with this protrusion, it is possible to improve homogeneity in the flow of the mixture of the second fluid and the third fluid.

It is particularly preferred that homogenization structure 46 include a flow inversion structure. The flow inversion structure is disposed downstream of “T” coupling 44 and includes a combination of a separation portion and a merging portion (both not shown). The mixture of the second fluid and the third fluid obtained in “T” coupling 44 has a concentration distribution in the radial direction of the flow channel. This mixture is separated into a plurality of flows in the separation portion and the flows then merge in the merging portion through the respective flow channels. It is preferable that each of the flow channels include a folded structure configured such that portions of the respective separated flows, the concentrations of which are greatly different from each other, come into contact with each other in the merging portion. Because the flow inversion structure has such a configuration, a more homogeneous mixture can be introduced into intersection region 38. The number of combinations of the separation portion and the merging portion included in the flow inversion structure is not limited to one, and a plurality of combinations may be used. It is particularly preferable that the number of provided combinations be within the range of 3 to 5.

Since mixing structure 30 thus includes homogenization structure 46, it is possible to further reduce the difference in concentration between the individual segments composed of the mixture of the second fluid and the third fluid formed in intersection region 38.

In some examples, second conduit 36 is formed such that there is no joint on the inner wall thereof at least in the section between mixing structure 30 and intersection region 38. In other examples, first conduit 34, second conduit 36, and mixing structure 30 may be machined from the same mold. Forming mixing structure 30 integrally with the second conduit in this way can help reduce the residence time and residence time distribution of the mixture upstream of intersection region 38. In this way, the abovementioned advantages of segmented flow can be more fully realized. In other examples, mixing structure 30 may be omitted or provided separately from the fluid-segmentation device 32.

Second conduit 36 of fluid-segmentation device 32 includes intersection region 38 to which the first conduit 34 is connected and into which the first fluid is introduced and a first region located downstream of intersection region 38. As shown in FIG. 2, second conduit 36 of fluid-segmentation device 32 is narrower in intersection region 38 and wider outside the intersection region. Here, the narrow/wide indicates the size of the cross-sectional area defined by the inner diameter or the conduit in a plane perpendicular to the flow direction of the second fluid. In particular, the second conduit includes a narrowing region 48 upstream of the intersection region in a direction of flow through the second conduit. The second conduit also includes a widening region 50 that widens continuously along the flow direction of the second fluid at a position between intersection region 38 and the first region. The cross-sectional area of intersection region 38 of second conduit 36 in a plane perpendicular to the flow direction of the second fluid is less than the cross-sectional area of the first region of second conduit 36 in a plane perpendicular to the flow direction of the second fluid.

In Some examples, each of narrowing region 48 and widening region 50 is a region of continuous change in cross-sectional area as a function of distance through second conduit 36. In other words, each cross section of the second conduit may be geometrically similar along narrowing region 48 and/or widening region 50. This feature, inter alia, may enable the second conduit to conduct a substantially laminar segmented flow from intersection region 38 through widening region 50. The segment thus formed shows an improved separation state and can stably maintain the separation state. In other examples, narrowing and widening regions may change width in steps and/or discrete segments, or may have any other suitable structure.

In the example of FIG. 2, second conduit 36 includes substantially constant-width portions 52 adjacent intersection region 38. A constant-width portion of the second conduit may be tubular—i.e., cylindrical. In other implementations, the constant-width portion may have a rectangular cross section, or any other suitable cross-section. Optionally, a conduit-fill sensor 54 may be coupled to constant-width portion 52. The conduit-fill sensor may be any sensor responsive to whether an associated locus of the conduit is filled with a gas (i.e., first fluid A) or with a liquid (i.e., second fluid B, or mixture of second and third fluids B+C). In some examples, electronic output from the conduit-fill sensor may be feedback to metering stage 40 to control the amount of the first fluid admitted into the intersection region. In this and other examples, the flow of the first fluid may be metered further based on net flow of the second fluid through the second conduit—to maintain a desired flow rate of the first fluid relative to that of the second fluid. In still other examples, the flow of the first fluid may be metered such that a bubble of the first fluid overfills (e.g., completely overfills or just overfills) the intersection region. In these and other examples, process controller 26 may be configured to receive output from conduit-fill sensor 54 (among other sensory components) and control the opening and closure of metering stage 40 (among other actuated process controls).

The configuration of fluid-segmentation device 32 may provide a number of advantages for continuous-flow reactor system 10. As one potential advantage, first fluid A is introduced into flowing mixture B+C in a region of second conduit 36 where the cross section is relatively small. This action may reliably create a relatively long bubble of the first fluid in constant-width portion 52, where the length of the bubble depends on the flow rate of the first fluid into intersection region 38 and on various contact forces. When the fully formed bobble flows past widening region 50, it shortens under the contact force with the conduit so as to fill the larger cross section of the second conduit downstream of the widening region. The bubble, smaller than could be made by directly introducing the first fluid into the full-width portion of the second conduit, maintains separation between adjacent segments of the flowing mixture despite its reduced length. One advantage of this effect is that the intervening segments of the first fluid can be made shorter at the point of delivery to downstream reaction processing devices 16. This means that for a given volume of reactant mixture, less of the first fluid is required to maintain segmentation. In scenarios where throughput is high, this feature can provide a potentially significant cost savings, even if the first fluid is relatively inexpensive. However, it will be understood that, in some scenarios, the first fluid may be relatively expensive, as it may include purified nitrogen, carbon dioxide, argon, or helium. These gasses may be used to provide a reduced-oxygen environment to protect oxidizable reactants, products, or intermediates. In such scenarios, the benefits offered by the disclosed examples may be particularly advantageous.

Another advantage of reducing consumption of the first fluid applies to scenarios in which the first fluid is undesirable for release into the environment (e.g. where release may be regulated by applicable law). A further advantage of shortening the intervening segments of the first fluid is that doing so enables the reaction mixture to more completely fill the reactor system, which increases overall throughput. Yet another advantage may be realized in examples as shown in FIG. 2, where feedback from conduit-fill sensor 54 is used to control the metering of the first fluid into the intersection region. Because the first fluid is introduced into a narrowed region of second conduit 36, a bubble of the first fluid at its point of introduction is long relative to its volume. This enables the first fluid to be metered with increased accuracy.

The fluid-segmentation device in the present embodiment includes: a first conduit in which a first fluid flows, and a second conduit in which a second fluid immiscible with the first fluid flows, wherein the second, conduit of the fluid-segmentation device includes an intersection region to which the first conduit is connected and the first fluid is introduced and a first region downstream of the intersection region, and a cross-sectional area of the intersection region of the second conduit in a plane perpendicular to the flow direction of the second fluid is less than a cross-sectional area of the first region of the second conduit in a plane perpendicular to the flow direction of the second fluid.

It is preferred that the inner diameter of the second conduit 36 be 1/16 inch or more in a zone between the “T” coupling 44 and the narrowing region 48. It is also preferred that the inner diameter be 1 inch or less, more preferably ¼ inch or less, even more preferably ⅛ inch or less in this zone.

To facilitate understanding, here, the first conduit and the second conduit are described as being cylindrical, that is, the cross-sectional shape of the conduit is described as being circular. The cross-sectional shape of these conduits is not necessarily circular, and may be rectangular or the like. When the cross-sectional shape is not circular, the shape can be regarded as a circle having the inner diameter such that the cross-sectional area is equal to that of the non-circular cross-sectional shape. The same applies hereinbelow unless otherwise specified.

The inner diameter of the pipe of constant-width portion 52 upstream of intersection region 38 is preferably ½ of the inner diameter of second conduit 36 in the section between “T” coupling 44 and narrowing region 48. For example, when the inner diameter of second conduit 36 in the section between the “T” coupling 44 and narrowing region 48 is ⅛ inch, it is preferable that the inner diameter of the pipe be about 1/16 inch. Further, by setting the length of constant-width portion 52 on the upstream side to be three limes or more the inner diameter of the pipe at that portion, a fine laminar-flow segment can be formed, in addition, it is more preferable that the length of constant-width portion 52 on the upstream side be not more than 5 times the inner diameter of the pipe at that portion.

The inner diameter of the pipe in the intersection region 38 is preferably 0.01 inch to ⅛ inch, more preferably 0.02 inch to 1/16 inch. It is particularly preferable

that the inner diameter of the pipe of intersection region 38, the inner diameter of the pipe of constant-width portion 52 upstream of intersection region 38, and the inner diameter of the pipe of constant-width portion 52 on the downstream side be about the same. Here, “about the same” means that the inner diameters of the pipes of constant-width portion 52 on the upstream side and the downstream side are both within a range of 0.8 times or more and 1.2 times or less the inner diameter of the pipe of intersection region 38. In addition, the cross-sectional area of intersection region 38 is preferably ⅛ times to 1/1.5 times, and more preferably ¼ times to ½ times the cross-sectional area of second conduit 36 in the first region downstream of widening region 50. With such a configuration, it is possible to further shorten the intervening segment of the first fluid at the time of delivering to the downstream side of widening region 50.

The cross-sectional area of first conduit 34 may be about the same as the cross-sectional area of the intersection region 38, or the cross-sectional area of first conduit 34 may be larger. For example, the cross-sectional area of the intersection region 38 is preferably ⅛ times to 1 times, preferably ¼ times to 1 times the cross-sectional area of the first conduit 34. Where the cross-sectional area of the intersection region 38 is small, the first fluid can be further stabilized before the segments are formed. The inner diameter of the first conduit 34 is preferably 1/16 inch or less.

The inner diameter of the pipe in the constant-width portion 52 downstream of the intersection region 38 is preferably about ½ times the inner diameter of the second conduit 36 in the zone between the “T” coupling 44 and the narrowing region 48, for example, about 1/16 inch. Further, since the length of constant-width portion 52 on the downstream side is five times or more the inner diameter of the pipe at that portion, a segment of a small laminar flow can be formed and the flow can be stabilized, it is even more preferable that the length be 15 times or less the inner diameter.

The widening region 50 includes a linear taper portion. In particular, where the taper angle thereof is set to 20° or less, the laminar flow segment can be formed continuously without destabilization. It is further preferred that the taper angle be within a range from 15° to 20°.

In particular, by making the inner diameter of the second conduit at a position downstream of intersection region 38 and within fluid-segmentation device 14 to be larger than the inner diameter of the pipe of intersection region 38 prior to introduction to reaction processing device 16, it is possible to obtain a stabilized segmented flow including intervening segments which are made shorter at the time of introduction into the reaction processing device 16 where processing such as energizing, activation and heating are performed.

It is preferable that second conduit 36 include a region with the inner diameter of the pipe which is two times or more the inner diameter of the pipe of intersection region 38 at a position where the second conduit passes through any one or more of reaction processing devices 16. As a result, it is possible to conduct the reaction more efficiently and/or obtain higher productivity in the reaction processing device 16. Further, even when a long reaction time is required, the length of second conduit 36 in reaction processing device 16 can be shortened.

In addition, when the reaction processing device 16 includes a processing device (for example, energized activation stage 18) having a shorter required reaction time and a processing device (for example, incubation stage 20) having a longer required reaction time, the inner diameter of second conduit 36 in the processing device with a longer required reaction time may be made larger than the inner diameter of second conduit 36 in the processing device with a shorter required reaction time.

Further, the inner diameter of second conduit 36 in a processing device including a step of nucleation and/or growth of nanoparticles may be made smaller than the inner diameter of second conduit 36 in a processing device including a step (e.g., cooling and/or recovery) subsequent to the aforementioned step. Specifically, when second conduit 36 in the processing device including the nucleation step of nanoparticles has a first inner diameter, second conduit 36 in the processing device including the step of growing the nucleated nanoparticles has a second inner diameter, and second conduit 36 in the processing device including the cooling step of the fluid including the grown nanoparticles has a third inner diameter, the first inner diameter may be smaller than the third inner diameter, the second inner diameter may be smaller than the third inner diameter, the first inner diameter may be smaller than the second inner diameter, or a combination of such conditions may be used. By doing so, it is possible to suppress the expansion of distribution of chemical properties and/or physical composition due to uneven distribution of residence time, while maintaining reaction efficiency and productivity.

It is also preferable to thermally insulate reaction processing device 16 from intersection region 38. For example, a separate configuration may be used such that the processing device in the reaction processing device and intersection region 38 are prepared separately from each other, instead of being integrally formed. A predetermined distance may be provided between intersection region 38 and the processing device closest to intersection region 38 in the reaction processing device. Although the predetermined distance is not particularly limited, it is preferably 5 inches or more, more preferably 10 inches or more. It is particularly preferable to provide a thermal insulating member between reaction processing device 16 and intersection region 38. Even when any one or more of the processing devices of reaction processing device 16 includes art input of energy accompanied by heating to second conduit 36, by providing thermal insulation therebetween such that the temperature rise in intersection region 38 caused by this heating can be ignored, it is possible to obtain more controlled and stable separation between the segments. In particular, when the first fluid is a gas, it is preferable to use such a configuration because the influence of volume changes due to temperature increases.

A method for producing nanoparticles according to an embodiment of the present invention includes: a step of introducing a first fluid into a conduit in which a second fluid immiscible with the first fluid flows, to form a segmented flow of the second fluid which is separated by intervening segments of the first fluid, and delivering the segmented flow toward a downstream in a flow direction of the second fluid; a step of passing the delivered segmented flow through a widening region of the conduit configured such that a cross-sectional area of the conduit in a plane perpendicular to the flow direction widens, thereby shortening the intervening segments of the segmented flow in the flow direction; and a step of introducing the segmented flow in which the intervening segments are shortened into the conduit arranged at a position passing through a reaction processing device including a processing device for causing the second fluid to react, and energizing and/or activating the second fluid of the segmented flow in the conduit. This method can be implemented using the continuous-flow reactor system according to an embodiment of the present invention.

The present invention is not limited to the embodiments as they are, and can be embodied by modifying constituent elements in the implementation stage without departing from the gist of the invention. Further, various inventions can be formed by appropriately combining a plurality of constituent elements disclosed in the embodiments. For example, some constituent, elements may be deleted from all the constituent elements shown in the embodiments. Further, the constituent elements of different embodiments may be appropriately combined. In addition, various modifications can be made without departing from the gist of the present invention.

The first embodiment of the present invention is also inclusive of the following aspects.

<1> A fluid-segmentation device comprising:

intersecting first and second conduits, the second conduit being narrower in a region of intersection with the first conduit, and wider outside the region of intersection;
the first conduit configured to admit a first fluid and introduce the first fluid into the second conduit in the region of intersection;
the second conduit configured to admit a second fluid and to conduct a sequence of flowing segments of the second fluid away from the region of intersection, separated by intervening segments of the first fluid.

<2> The fluid-segmentation device of <1> wherein the first fluid is a gas, and the second fluid is a liquid.

<3> The fluid-segmentation device of <1> or <2> wherein the second conduit includes a narrowing region upstream of the region of intersection in a direction of flow through the second conduit.

<4> The fluid-segmentation device of any one of <1> to <3> wherein the second conduit includes a widening region downstream of the region of intersection in a direction of flow through the second conduit.

<5> The fluid-segmentation device of <4> wherein the widening region is a region of continuous widening along the direction of flow through the second conduit.

<6> The fluid-segmentation device of <4> or <5> wherein the second conduit is configured to conduct a substantially laminar flow from the region of intersection through the widening region.

<7> The fluid-segmentation device of any one of <1> to <6> wherein the second conduit has substantially constant width along a portion adjacent the region of intersection.

<8> The fluid-segmentation device of <7> wherein the portion adjacent the region of intersection is cylindrical or rectangular in cross section.

<9> The fluid-segmentation device of any one of <1> to <8> wherein the first conduit includes a nozzle that penetrates into the second conduit.

<10> A flow mixing and segmentation device, comprising:

intersecting first and second conduits, the second conduit being narrower in a region of
intersection with the first conduit, and wider outside the region of intersection; and
coupled to the second conduit upstream of the region of intersection, a mixing structure configured to admit second and third fluids, and to release a mixture of the second and third fluids through the second conduit and into the region of intersection;
the first conduit configured to admit a first fluid, and the second conduit configured to conduct a sequence of flowing segments of the mixture away from the region of intersection, separated by intervening segments of the first fluid.

<11> The flow mixing and segmentation device of <10> wherein the first and second conduits and the mixing structure are machined from a same die.

<12> The flow mixing and segmentation device of <10> or <11> wherein the mixing structure includes a “T” coupling in which the second and third fluids approach the second conduit from opposite directions along a same axis.

<13> The flow mixing and segmentation device of any one of <10> to <12> wherein the mixing structure includes a flow inversion structure.

<14> A continuous-flow reactor system comprising:

intersecting first and second conduits, the second conduit being narrower in a region of intersection with the first conduit, and wider outside the region of intersection,

the first conduit being configured to admit a first fluid,

the second conduit being configured to admit a second fluid and to conduct a sequence of flowing segments of the second fluid separated by intervening segments of the first fluid away from the region of intersection;

a mixing device connected to the second conduit upstream of the intersection region; and

a reaction processing device including at least one processing device connected to the second conduit downstream of the intersection region.

<15> The continuous-flow reactor system of <14> further comprising a metering stage to control an amount of the first fluid admitted into the region of intersection.

<16> The continuous-flow reactor system of <14> or <15> further comprising a conduit-fill sensor arranged along a portion of the second conduit adjacent the region of intersection, the conduit-fill sensor providing feedback for metering the first fluid.

<17> The continuous-flow reactor system of <16> wherein the flow of the first fluid is metered based on flow of the second fluid through the second conduit.

<18> The continuous-flow reactor system of any one of <14> to <17> wherein the flow of the first fluid is metered such that a bubble of the first fluid overfills the region of intersection.

<19> The continuous-flow reactor system of any one of <14> to <18> wherein the reaction processing device includes an incubation stage fluidically downstream of an energized activation stage.

<20> The continuous-flow reactor system of <19> wherein the reaction processing device includes a shell-forming stage fluidically downstream of the incubation stage.

<21> A method for producing nanoparticles comprising:

a step of preparing the fluid-segmentation device of <1>, and

a step of introducing a sequence of flowing segments of the second fluid separated by intervening segments of the first fluid to a reaction processing device including at least one processing device connected to the second conduit.

<22> A method for producing nanoparticles, comprising:

a step of introducing a first fluid into a conduit in which a second fluid immiscible with the first fluid flows; and

a step of performing, inside the conduit, energized activation of the second fluid into which the first fluid has been introduced, wherein

a cross-sectional area of the conduit at a position where the first fluid is introduced is less than the cross-sectional area of the conduit at a position where the energized activation is performed.

<23> An apparatus for producing nanoparticles comprising a conduit configured to allow a fluid to flow from an upstream side to a downstream side,

the conduit comprising a first compartment for energizing a fluid including a nanoparticle precursor to nucleate the nanoparticles; and

a second compartment for quenching a fluid including the nanoparticles nucleated in the first compartment, wherein

an inner diameter of the conduit in the first compartment is smaller than an inner diameter of the conduit In the second compartment.

### Second Embodiment

Examples are disclosed that relate to analysis of fluid segments in a continuous-flow reactor system. One example provides an analytical device for a continuous-flow reactor system, the analytical device including a conduit receiver configured to extend at least partially around a second conduit of the continuous-flow reactor system, an upstream conduit-fill sensor coupled to the conduit receiver at a location configured to be positioned adjacent a first portion of the conduit, a downstream conduit-fill sensor coupled to the conduit receiver at a location configured to be positioned adjacent a second portion of the conduit, and an analytical sensor coupled to the conduit receiver at a location configured to be positioned adjacent a third portion of the conduit, the second location being downstream of the first location and upstream of the third location in a direction of analyte flow.

The Summary above is provided to introduce a selected part of this disclosure in simplified form, not to identify key or essential features. The claimed subject matter, defined by the claims, is limited neither to the content of this Summary nor to implementations that address the problems or disadvantages noted herein.

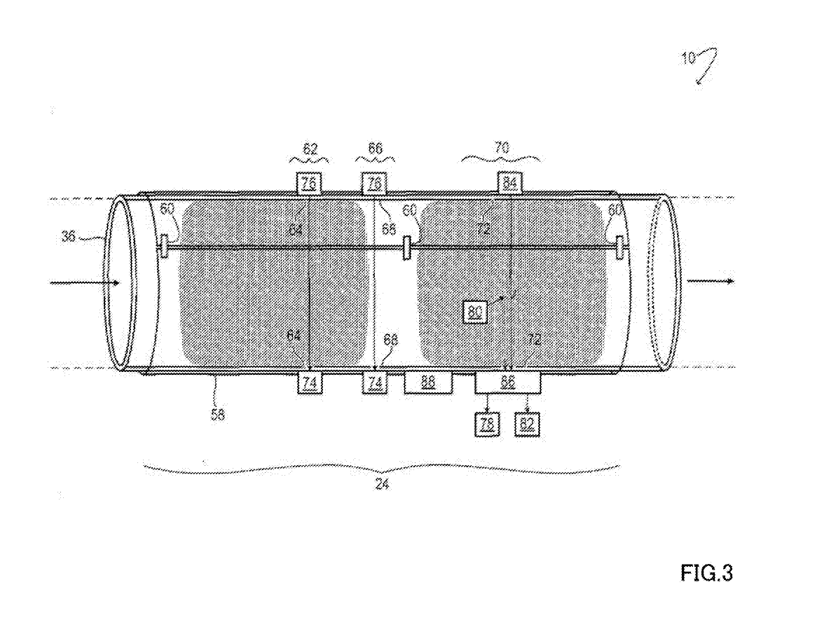

FIG. 3 shows aspects of an example embodiment of the analytical device 24. The analytical device 24 is configured to releasably couple to second conduit 36 of reactor system 10. As noted above, the second conduit may carry a sequence of flowing segments of an analyte fluid (e.g., a liquid containing a reaction mixture or product) separated by intervening segments of an immiscible, non-reacting fluid (e.g., a gas). Although a straight portion of conduit is shown in the drawing, an analytical device according to the present disclosure may be coupled to a conduit of any suitable configuration, whether curved or angled, etc.

The analytical device 24 includes a conduit receiver in the form of a cuff 58. Open at both ends, the cuff 58 acts as a device housing for at least a portion of the analytical device, and is configured to receive and extend at least partially around second conduit 36. In some embodiments, second conduit 36 may be one of a plurality of conduits that the cuff is configured to receive. Accordingly, the cuff may be configured to non-destructively engage and release second conduit 36 and to receive another of the conduits located elsewhere in the continuous-flow reactor system. To this end, cuff 58 includes clamping portions 60 configured to releasably fix the cuff at least partially around the received conduit. Each clamping portion may include one or more mechanisms, e.g. one or more screws, latches, etc., to fix the clamping portion in a desired position around the conduit. In other implementations, the conduit receiver may be held around a conduit in any other suitable manner, e.g. via spring force. It will be understood that the shape and configuration of the depicted cuff is shown for the purpose of example, and is not intended to be limiting in any manner, as a conduit receiver according to the present disclosure may have any suitable shape and/or size.

In the embodiment of FIG. 3, the analytical device 24 further includes upstream and downstream conduit-fill sensors, and an analytical sensor. Upstream conduit-fill sensor 62 is mechanically coupled to cuff 58 at a location that places it adjacent a first portion 64 of second conduit 36. Downstream conduit-fill sensor 66 is mechanically coupled to cuff 58 at a location that places it adjacent a second portion 68 of second conduit 36 located downstream of the first portion 64 in a direction of analyte flow. Analytical sensor 70 is mechanically coupled to cuff 58 at a location that places it adjacent a third portion 72 of second conduit 36 that is downstream of the first portion and second portion in a direction of analyte flow. In some embodiments, the upstream conduit-fill sensor, the downstream conduit-fill sensor, and the analytical sensor are fixedly coupled to the cuff, such that the first, second, and third portions of the conduit are separated by fixed distances. In other embodiments, these components may be coupled slidably to the cuff via a groove or track, such that the separation between components is adjustable.

In some embodiments, each of the upstream and downstream conduit-fill sensors may be an optical sensor responsive to the presence of liquid in the associated portions of second conduit 36. Coupled to cuff 58 and spanning first and second portions of the second conduit, these upstream and downstream optical sensors may comprise an optical sensory device responsive to the length and velocity of a segment of a liquid flowing through the second conduit. At least one of the upstream and downstream optical sensors may include a photodetector 74—e.g., a photodiode or phototransistor. Likewise, at least one of the upstream and downstream optical sensors may include an illumination source 76, such as a light-emitting diode (LED). In the illustrated embodiment, each of the upstream and downstream conduit-fill sensors includes both a photodetector and an illumination source, but other arrangements also may be used. For example, in some embodiments, the upstream and downstream conduit-fill sensors may share an illumination source but have their own photodetectors. In other embodiments, the upstream and downstream sensors may share a photodetector but have their own, multiplexed, illumination sources. Naturally, the wavelength response of the photodetector may be matched to that of the illumination source, and/or suitable optical filters may be used, to provide a desirable signal-to-noise ratio.

Sensory configurations operating on other physical principles than optical sensing also may be used. For example, segment length and velocity sensors may be acoustic or conductometric. Further, some sensory configurations may be directly responsive to the length and velocity of the flowing gas portion of the segmented flow, rather than the flowing liquid portion. Irrespective of any particular sensor configuration, a conduit-fill sensor may provide a substantially two-state output reflecting whether the associated portion of the conduit is filled with a first fluid (e.g., the immiscible, non-reacting fluid or gas, state A), or whether it is filled with a second fluid B (e.g., the analyte liquid, state B). In this and other embodiments, the conduit-fill sensor may provide a differential response when a meniscus between first and second fluids passes through the locus of the conduit where the conduit-fill sensor is arranged.

In the embodiment of FIG. 3, analytical sensor 70 is a multimode sensor, and includes emission sensor 78 and associated excitation source 80, as well as attenuation sensor 82 and associated illumination source 84. Excitation source 80 is configured to provide excitation of a chemical species in the analyte portion of the fluid passing through second conduit 36, while emission sensor 78 is configured to detect emission—viz., fluorescence, phosphorescence, or combinations thereof—from the excited species. The excitation source may be configured to provide any desired intensity of irradiation in any desired wavelength band—visible, ultraviolet, or x-ray, for example. In some embodiments, the excitation source may include a laser. In other embodiments, the excitation source may include a broadband discharge lamp and wavelength-selective filter. Likewise, emission sensor 78 may be configured to detect emission in any desired wavelength range, including but not limited to near infrared (NIR), visible, ultraviolet, or x-ray.

Attenuation sensor 82 is configured to detect loss or attenuation of probe-beam intensity from associated illumination source 84. The illumination source may be configured to provide illumination in any desired wavelength range—radio frequency (RF), microwave, infrared, NIR, visible, or ultraviolet, for example. In one embodiment, the attenuation sensor may be configured to quantify the ratiometric transmittance of the probe beam through the conduit, referenced to a state in which the conduit is unfilled, filled only with the first fluid, etc. Attenuation may arise from various sources, including but not limited to absorption of probe-beam intensity, scattering of probe-beam intensity, and/or combinations thereof.

In one embodiment, both emission sensor 78 and attenuation sensor 82 may be configured as broadband sensors and associated with suitably narrow band-excitation sources. In other embodiments, at least one of the emission sensor and the attenuation sensor may include a spectrometer configured for wavelength-dispersive measurement. To that end, at least one of the emission sensor and the attenuation sensor may include a grating or prism, and/or componentry to enact a Fourier-transform (FT) spectral measurement. In embodiments where a multimode analytical sensor 70 includes both emission and attenuation sensors, entry pupils of the emission and attenuation sensors may be arranged optically downstream of a beam splitter, such as fiber-optic beam splitter 86 of FIG. 3.

Continuing in FIG. 3, analytical device 24 also Includes an analytical controller 88, configured to trigger acquisition of analytical data based on output from the upstream and downstream conduit-fill sensors. Such analytical data may include an emission spectrum, a transmission spectrum, a light-scattering assay, etc.

Analytical controller 88 may receive output from the upstream and downstream conduit-fill sensors (e.g., optical sensory device output) and use the output to compute the length of a segment of the second fluid as well as the flow velocity. These parameters can be used to determine an appropriate time window for acquisition of analytical data by analytical sensor 70. Typically, the chosen time window will be a window in which the third portion of second conduit 36 (the portion subject to the analytical measurement) is completely filled by the analyte fluid. In other words, the appropriate time window may be one in which no meniscus is present in the third portion. To this end, the analytical controller may be configured to advance liming of the acquisition in response to a decrease in an interval between response (i.e., a change in output suite) of the upstream conduit-fill sensor and response of the downstream conduit-fill sensor. Further, the controller may be configured to cancel the acquisition based on output from the upstream and downstream conduit-fill sensors. The acquisition may be cancelled, for instance, in the event that a segment of the analyte is missing or is unexpectedly short. In some embodiments, the functionality of analytical controller 88 may be enacted in process controller 26 of FIG. 1. Electrical connections between analytical controller 88 and other components controlled by the analytical controller are omitted in FIG. 3 for clarity, but it will be understood that analytical controller 88 may be electrically connected to any suitable components, including but not limited to the components of the upstream conduit-fill sensor 62, the downstream conduit-fill sensor 66, and the analytical sensor 70.

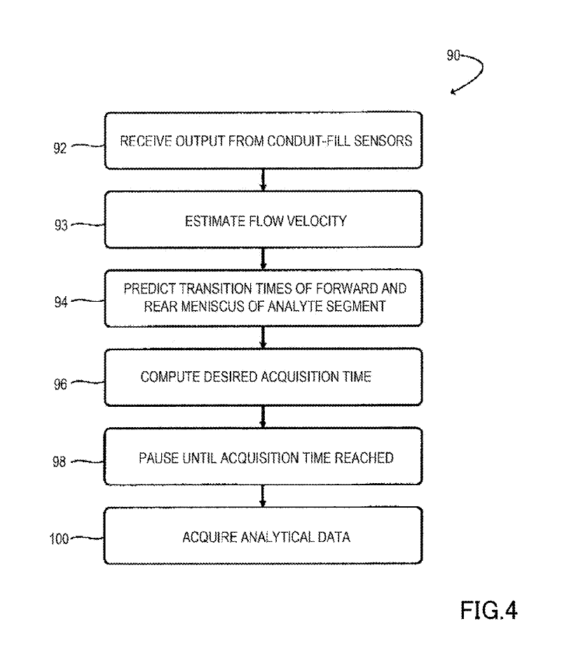

FIG. 4 illustrates an example process flow 90 to control the timing of the acquisition of analytical data by analytical sensor 70. This method may be enacted in analytical controller 88. At 92, output from upstream conduit-fill sensor 62 and downstream conduit-fill sensor 66 is received in analytical controller 88. In the analytical controller, the output may be digitized, conditioned, thresholded, etc., so as to determine whether the respective first and second portions of the conduit are filled with analyte or with immiscible, non-reacting fluid. In this manner, the transition times of the various forward (leading) and rear (trailing) meniscuses of the analyte in the segmented flow may be determined.

At 93 the flow velocity of a segment of second fluid in second conduit 36 is estimated. The velocity V may be computed, for example, according to the formula V=D12/(F2−F1), where F1 is the transition time when a forward meniscus of an analyte segment flows past upstream conduit-fill sensor 62, F2 is the time when the forward meniscus flows past downstream conduit-fill sensor 66, and D12 is the known distance of separation between first portion 64 and second portion 68 of the second conduit. The velocity may also be computed based on the transition times R1, R2 of the rear meniscuses of the segment. In one embodiment, three different velocities may be computed: a forward meniscus velocity, a rear meniscus velocity, and an average of these In this and other embodiments, the transition times F1, F2, R1 and R2 are equated to the timing of a state change of the upstream and downstream conduit-fill sensors.

At 94 the transition times of the forward and rear meniscuses of the analyte segment at the third portion of the conduit are predicted. The transition time of the forward meniscus F3 may be predicted as F3=D23/V, and the transition time of the rear meniscus R3 may be predicted as R3=D23/V, where D23 is the known distance of separation between the third portion 72 and the second portion 68 of the second conduit.

At 96, the desired acquisition time T is computed. In the simplest case, T may be computed as the average of F3 and R3—that is, T=0.5*(F3+R3). In this implementation, analytical data is acquired midway between the forward and rear mensicuses. In other implementations, the 0.5 value may be adjusted as a parameter in the analytical controller software. In still other implementations, the delay may be set as a distance, so that, appropriate timing is maintained despite excursions in the flow rate (if any). Accordingly, one useful approach admits of a real, measurable D23; however, the D23 value stored in the analytical controller may be altered based on observed data—so as to cut out the forward meniscus. This feature is especially useful for analyses conducted across different solvent systems, which may have different meniscus properties. Continuing in FIG. 4, at 98, acquisition of analytical data is paused until time T. Then, at time T, analytical sensor 70 is triggered to acquire data, at 100 of process flow 90.

As indicated hereinabove, the second embodiment of the present invention is also inclusive of the following aspects.

[1] An analytical device for a continuous-flow reactor system, the analytical device comprising:

a conduit receiver configured to extend at least partially around a conduit of the continuous-flow reactor system;
an upstream conduit-fill sensor coupled to the conduit receiver at a location configured to be positioned adjacent a first portion of the conduit;
a downstream conduit-fill sensor coupled to the conduit receiver at a location configured to be positioned adjacent a second portion of the conduit; and
an analytical sensor coupled to the conduit receiver at a location configured to be positioned adjacent a third portion of the conduit, the second location being downstream of the first location and upstream of the third location in a direction of analyte flow.

[2] The analytical device of [1] wherein the upstream conduit-fill sensor, the downstream conduit-fill sensor, and the analytical sensor are fixedly coupled to the conduit receiver, such that the first, second, and third portions of the conduit are separated by fixed distances.

[3] The analytical device of [1] or [2] wherein the conduit receiver includes a clamping portion to releasably fix the conduit receiver at least partially around the conduit.

[4] The analytical device of any one of [1] to [3] further comprising a controller configured to trigger acquisition of analytical data by the analytical sensor based on output from the upstream and downstream conduit-fill sensors.

[5] The analytical device of [4] wherein the controller is configured to advance timing of the acquisition in response to a decrease in an interval between response of the upstream conduit-fill sensor and response of the downstream conduit-fill sensor.

[6] The analytical device of [4] or [5] wherein the controller is configured to cancel the acquisition based on output from the upstream and downstream conduit-fill sensors.

[7] The analytical device of any one of [1] to [6] wherein the analytical sensor comprises a multimode sensor.

[8] The analytical device of any one of [1] to [7] wherein the analytical sensor includes an emission sensor and associated excitation source.

[9] The analytical device of [8] wherein the excitation source includes a laser.

[10] The analytical device of any one of [1] to [9] wherein the analytical sensor includes an attenuation sensor and associated illumination source.

[11] The analytical device of any one of [1] to [10] wherein the analytical sensor includes at least one spectrometer.

[12] An analytical device comprising:

a conduit receiver configured to receive a conduit;
coupled to the conduit receiver, an optical sensory device responsive to length and velocity of a segment of liquid flowing through the conduit; and
an analytical, sensor coupled to the conduit receiver at a location downstream, of the optical sensory device in an analyte flow direction.

[13] The analytical device of [12] wherein the optical sensory device includes an upstream optical sensor at a first location on the conduit receiver and a downstream optical sensor at a second location on the conduit receiver downstream of the first location in the analyte flow direction.

[14] The analytical device of [13] wherein at least one of the upstream and downstream optical sensors includes a photodetector.

[15] The analytical device of [13] or [14] wherein at least one of the upstream and downstream optical sensors includes an illumination source.

[16] The analytical device of any one of [12] to [15] wherein conduit receiver is configured to releasably clamp at least partially around the conduit.

[17] An analytical device for a continuous-flow reactor system, the analytical device comprising:

a conduit receiver configured to be positioned releasably around a conduit;
an upstream conduit-fill sensor coupled to the conduit receiver at a first location on the conduit receiver;
a downstream conduit-fill sensor coupled to the conduit receiver at a second location on the conduit receiver downstream of the first location in an analyte flow direction; and
an emission spectrometer and associated excitation source, each coupled to the conduit receiver adjacent a third location on the conduit receiver downstream of the first location and the second location in the analyte flow direction.

[18] The analytical device of [17] further comprising a controller configured to trigger acquisition of an emission spectrum based on output from the upstream and downstream conduit-fill sensors.

[19] The analytical device of [18] further comprising an attenuation spectrometer and associated illumination source, each coupled to the conduit receiver, adjacent the third portion of the conduit, wherein the controller is further configured to trigger acquisition of an attenuation spectrum, based on the output from the upstream and downstream conduit-fill sensors.

[20] The analytical device of [19] wherein entry pupils of the emission and attenuation spectrometers are arranged optically downstream of a beam splitter.

It will be understood that the configurations and/or approaches described herein are presented for example, and that these specific examples or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. The subject matter of the present disclosure includes all novel and non-obvious combinations and subcombinations of the various processes, systems and configurations, and other features, functions, acts, and/or properties disclosed herein, as well as any and all equivalents thereof.

### REFERENCE SIGNS LIST

10 continuous-flow reactor system
12A first fluid source
12B second fluid source
12C third fluid source
14 flow mixing and segmentation device
16 reaction processing devices
18 energized activation stage
20 incubation stage
22 collection stage
24 analytical device
26 process controller
28 shell fabrication stage
30 mixing structure
32 fluid-segmentation device
34 first conduit
36 second conduit
35 intersection region
40 metering stage
42 nozzle
44 “T” coupling
46 homogenization structure
48 narrowing region
50 widening region
52 constant-width portions
54 conduit-fill sensor
60 clamping portions
62 upstream conduit-fill sensor
64 first portion of second conduit
66 downstream conduit-fill sensor
68 second portion of second conduit
70 analytical sensor
72 third portion of second conduit
74 photodetector
76 illumination source
78 emission sensor
80 excitation source
82 attenuation sensor
84 illumination source
86 fiber-optic beam splitter
90 process flow
X flow direction of second fluid

1-13. (canceled)

14. A method for producing nanoparticles
by using a second fluid containing precursors of nanoparticles,
a first fluid which is immiscible and non-reacting with the second fluid,
a first conduit in which the first fluid flows, and
a second conduit in which the second fluid flows
by forming a segmented flow of the second fluid, which is separated by intervening segments of the first fluid, and by energizing and/or activating the segmented flow,
wherein the second conduit comprises at least
a region of intersection in which the first conduit and the second conduit intersect, and
a widening region located downstream of the region of intersection in a flow direction of the second fluid and configured such that a cross-sectional area of the second conduit in a plane perpendicular to the flow direction widens,
by introducing the intervening segments of the first fluid from the first conduit to the second conduit to form the segmented flow
and by passing the segmented flow through a widening region of the conduit, thereby making the intervening segments of the segmented flow in the flow direction downstream of the widening region shorter than the intervening segments of the segmented flow in the flow direction upstream of the widening region.

15. The method for producing nanoparticles according to claim 14, wherein the first fluid is a gas and the second fluid is a liquid.

16. The method for producing nanoparticles according to claim 14, wherein the second conduit has a first region downstream of the widening region in which the segmented flow is stabilized.

17. The method for producing nanoparticles according to claim 15, wherein the second conduit has a first region downstream of the widening region in which the segmented flow is stabilized.

18. The method for producing nanoparticles according to claim 16, wherein energizing and/or activating the segmented flow is performed downstream of the first region

19. The method for producing nanoparticles according to claim 17, wherein energizing and/or activating the segmented flow is performed downstream of the first region

20. The method for producing nanoparticles according to claim 18, wherein the region of intersection and a region in which energizing and/or activating are thermally insulated.

21. The method for producing nanoparticles according to claim 19, wherein the region of intersection and a region in which energizing and/or activating are thermally insulated.

22. The method for producing nanoparticles according to claim 14, wherein the second conduit further includes a constant-width portion, having a cross-sectional area equal to the intersection region, between the intersection region and the widening region.

23. The method for producing nanoparticles according to claim 15, wherein the second conduit further includes a constant-width portion, having a cross-sectional area equal to the intersection region, between the intersection region and the widening region.

24. The method for producing nanoparticles according to claim 14, wherein an amount of the first fluid introduced into the intersection region is controlled on the basis of a flow rate of the second fluid.

25. The method for producing nanoparticles according to claim 15, wherein an amount of the first fluid introduced into the intersection region is controlled on the basis of a flow rate of the second fluid.

26. The method for producing nanoparticles according to claim 14, wherein a plurality of fluids which are immiscible and non-reacting with the first fluid flow in the second conduit.

27. The method for producing nanoparticles according to claim 15, wherein a plurality of fluids which are immiscible and non-reacting with the first fluid flow in the second conduit.

28. The method for producing nanoparticles according to claim 26, wherein the plurality of fluids are mixed upstream of the region of intersection and introduced to the second conduit.

29. The method for producing nanoparticles according to claim 27, wherein the plurality of fluids are mixed upstream of the region of intersection and introduced to the second conduit.

30. The method for producing nanoparticles according to claim 28, wherein the plurality of fluids are mixed and homogenized and then are introduced to the second conduit.

31. The method for producing nanoparticles according to claim 29, wherein the plurality of fluids are mixed and homogenized and then are introduced to the second conduit.

32. The method for producing nanoparticles according to claim 14, wherein species and/or amount of the fluid flowing the second conduit is measured.

33. The method for producing nanoparticles according to claim 15, wherein species and/or amount of the fluid flowing the second conduit is measured.
